(19) United States
(12) Patent Application Publication
(10) Pub. No.: US 2015/0088475 A1
(43) Pub. Date: Mar. 26, 2015

(54) SPACE DEBRIS VISUALIZATION, CHARACTERIZATION AND VOLUME MODELING

(71) Applicant: The Aerospace Corporation, El Segundo, CA (US)

(72) Inventors: Ryan Edward George McKennon-Kelly, Arlington, VA (US); Felix Roach Hoots, JR., Clifton, VA (US)

(73) Assignee: The Aerospace Corporation, El Segundo, CA (US)

(21) Appl. No.: 14/038,403

(22) Filed: Sep. 26, 2013

(51) Int. Cl. B64G 3/00

(52) U.S. Cl. CPC B64G 3/00
USPC 703/6

(57) ABSTRACT

Embodiments may include systems and methods for visualizing a positional probability of a plurality of objects in space. According to one embodiment, a method may be provided for visualizing a positional probability of a plurality of objects in space. The method may include receiving, by a computing system comprising one or more processors, an initial position for each of the plurality of objects at a given time. The method may further include determining a non-convex boundary around the plurality of objects. The method may additionally include generating a three-dimensional representation of the positional probability of the objects in space, based on the non-convex boundary.

### BACKGROUND

Since the first satellite, Sputnik, was launched in 1957, thousands of additional satellites have been launched into space, but only about 10% of these satellites are currently active. Therefore, the earth is being orbited by a huge number of non-functional satellites, discarded rocket stages, and fragments formed from explosions or collisions with other spacecraft. It is estimated that over 40% of the debris objects in space have diameters less than 3 cm, yet such small objects can create significant impact damage to other satellites. Orbiting space debris is becoming an increasing problem for spacecraft operators.

The United States Space Surveillance Network tracks and catalogs any space debris larger than 5-10 cm in low earth orbit (within 2,000 km of earth's surface), and any space debris larger than 30 cm to 1 meter in the geostationary ring (about 35,800 km above the earth). There are currently over 11 space agencies around the world trying to address the problem of space debris. The agencies are addressing the problem, on one hand, by attempting to limit the space debris population growth, by limiting the number of objects that are launched into space, and, on the other hand, by taking steps to insure that the objects launched do not explode or collide with other objects to create more debris.

Databases have been developed to catalog breakup events and known space debris. Furthermore, sophisticated models exist for predicting the risk of debris collisions with other spacecraft. The models provide detailed risk assessments as a function of time, and the results are generally presented in tabular form. However, a need remains for improved systems and methods for visualizing space debris events.

### BRIEF SUMMARY

Some or all of the above needs may be addressed by certain embodiments of the disclosure. Certain embodiments of the disclosure may include systems and methods for visualizing a positional probability of a plurality of objects in space.

According to one embodiment, a method may be provided for visualizing a positional probability of a plurality of objects in space. The method may include receiving, by a computing system comprising one or more processors, an initial position for each of the plurality of objects at a given time. The method may further include determining a non-convex boundary around the plurality of objects. The method may additionally include generating a three-dimensional representation of the positional probability of the objects in space, based on the non-convex boundary.

According to one embodiment, a system may be provided for visualizing a positional probability of a plurality of objects in space. The system may include at least one memory for storing computer-executable instructions. The system also may include at least one processor in communication with the at least one memory, the processor configured to execute the computer-executable instructions to receive an initial position for each of the plurality of objects at a given time. The processor may further be configured to determine a non-convex boundary around the plurality of objects. Further, the processor may be configured to generate a three-dimensional representation of the positional probability of the objects in space, based on the non-convex boundary.

According to one embodiment, a computer program product comprising a computer-readable medium may be provided. The computer-readable medium may have computer-executable instructions embodied therein, that when executed by at least one processor, visualize a positional probability of a plurality of objects in space. The instructions may cause the processor to receive an initial position for each of the plurality of objects at a given time. The instructions may further cause the processor to determine a non-convex boundary around the plurality of objects. Further, the instructions may cause the processor to generate a three-dimensional representation of the positional probability of the objects in space, based on the non-convex boundary.

Other embodiments and aspects are described in detail herein and can be understood with reference to the following detailed description, accompanying drawings, and claims.

### BRIEF DESCRIPTION OF THE FIGURES

Reference will now be made to the accompanying figures, plots, block diagrams, and flow diagrams, which are not necessarily drawn to scale, and wherein:

FIG. 1 is a representation of a space debris visualization utilizing pixels.

FIG. 2 is an illustration of a representation of positional probability of space debris, according to one embodiment.

FIG. 3 is a pictorial representation of a point cloud representing a plurality of space debris objects, according to one embodiment.

FIG. 4 is a pictorial representation of a triangulation of a point cloud representing a plurality of space debris objects, according to one embodiment.

FIG. 5 is a pictorial representation of a constrained triangulation of a point cloud representing a plurality of space debris objects, according to one embodiment.

FIG. 6 is a pictorial representation of a boundary surface and a point cloud representing a plurality of space debris objects, according to one embodiment.

FIG. 7 is a further illustration of a representation of positional probability of space debris, according to one embodiment.

FIG. 8 is a block diagram of a space debris visualization system, according to one embodiment.

FIG. 9 is a flow diagram of an example method, according to one embodiment.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

Embodiments will be described more fully hereinafter with reference to the accompanying drawings, in which embodiments are shown. Embodiments may take many different forms and should not be construed as limited to the specific examples set forth herein; rather, these embodiments are provided so that this disclosure will be thorough and complete. Like numbers refer to like elements throughout.

Embodiments disclosed herein include methods of generating three-dimensional surfaces that enclose a plurality of orbital debris particles. Embodiments include methods for producing a three-dimensional model of a space debris cloud. The three-dimensional model may incorporate the use of color and transparency to provide an accurate visualization of the debris cloud's extent, and the debris cloud's potential danger to orbiting satellites. Embodiments may produce a closed three-dimensional cloud, to which computational geometric methods may be applied to determine whether an orbiting satellite will collide with the cloud. Such embodiments may provide an efficient way to determine quickly whether a satellite of interest will pass through the debris cloud, and at what time such a crossing may occur.

Space debris visualization remains an important focus for government entities and other parties who wish to determine whether an orbiting satellite will suffer damage from debris generated from a breakup event. Such breakup events may include benign natural phenomena, or events such as two satellites colliding with each other. Breakup events may generate millions of particles, and the phenomenology of such events varies from one satellite system to another.

Some methods of visualization analyze space debris particles as particle swarms, in which each particle of debris is simulated, propagated, and analyzed individually. This individual analysis may be accurate, but may suffer from drawbacks. First, some breakup events result in more than 50,000 space debris particles. When trying to analyze the risk to orbiting satellites, each particle must be analyzed individually, adding significant complexity to the analysis. For example, collision risk for a satellite may be characterized using the distance from a piece of debris to the satellite. This distance must be computed for all or a significant portion of the debris particles that are considered to make up a dense “cloud” of debris. However, certain particles may not be tracked or represented in such a discrete simulation, leaving gaps in the knowledge of the debris position, and therefor risk. A more meaningful and important consideration is whether or not the satellite of interest is actually located within the cloud of debris, but the individual analysis method only determines distance and risk for individual particles, and not clouds of particles.

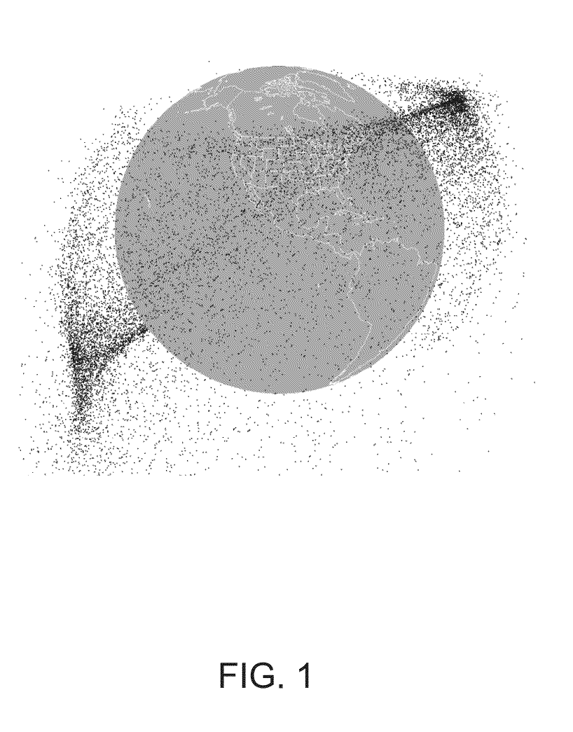

Another drawback to representing the space debris as a cloud of points is that such a method may misrepresent the scale and severity of the breakup event. For example, representing each object as a pixel on a computer display grossly over represents the size of such a particle. Such an example representation is shown in FIG. 1. Such a portrayal may give an unnecessarily pessimistic view of the debris density in space. As an example, if a representation of the Earth were displayed on a monitor having a 2560×1600 resolution, and if the Earth was projected at the maximum height (i.e. 1600 pixels), an individual debris particle would appear as nearly 8 meters long. Typical debris particles are much smaller, usually measured in centimeters.

Other methods of visualizing space debris particles avoid the aforementioned problems by developing a model of the distribution of the particles after the debris has spread out over the Earth. Such methods visualize the distribution of the debris particles as a ring structure, transforming the discrete particles into a field representation. However, such methods are unable to create a useful visualization until 12 to 48 hours after a breakup event. Thus, these methods are not as useful in the critical time period shortly after a breakup event.

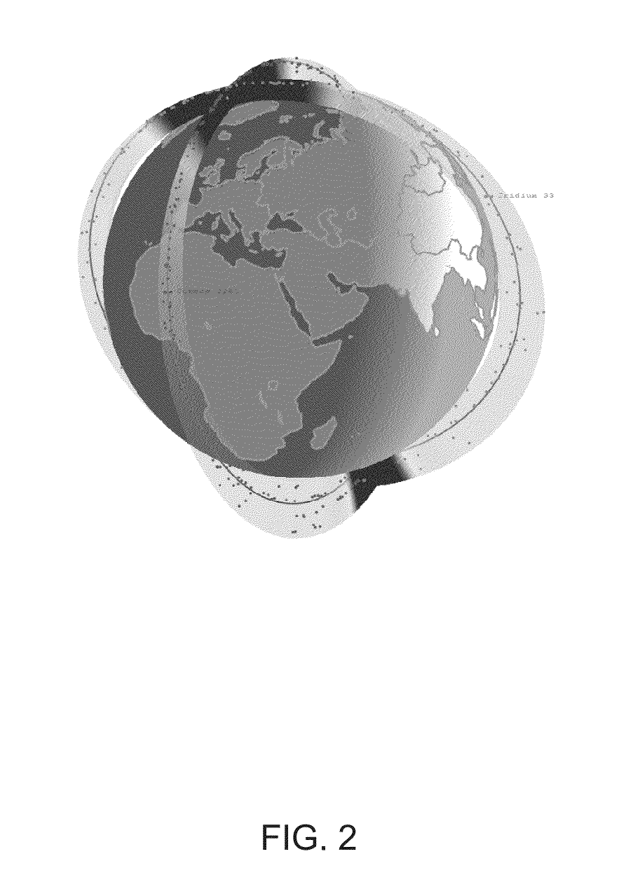

Thus, in one embodiment, a three-dimensional surface, or Torus, may be generated to enclose a cloud of debris particles resulting from a breakup event. Color and transparency may be applied to the Torus to accurately convey the extent and potential danger of a cloud of space debris. An example three-dimensional Torus is shown in FIG. 2. The three-dimensional surface can be used to represent a “danger zone” from which quick conclusions may be drawn. If an orbiting satellite does not move through the “danger zone”, the operators of the satellite need not take corrective action. Further, the solid three-dimensional surface may be used to calculate an accumulated “debris flux.” Embodiments provide for generating the three-dimensional surface at discrete times, and for animating a model of the debris particles resulting from a breakup event.

Certain embodiments described herein use, as input, data regarding the nature of the breakup event. Such data may include, but is not limited to, the size of the satellites or other colliding objects, the speed of those objects prior to collision, and other such information. Further, certain embodiments described herein create simulations of the ensuing debris particles to ascertain the positions of the particles in space and time. Given this positional data, embodiments create a three-dimensional surface to represent the positional probability of the debris particles. In one embodiment, a collection of simulated points can also be used to predict the positional probability of space debris particles after a breakup event.

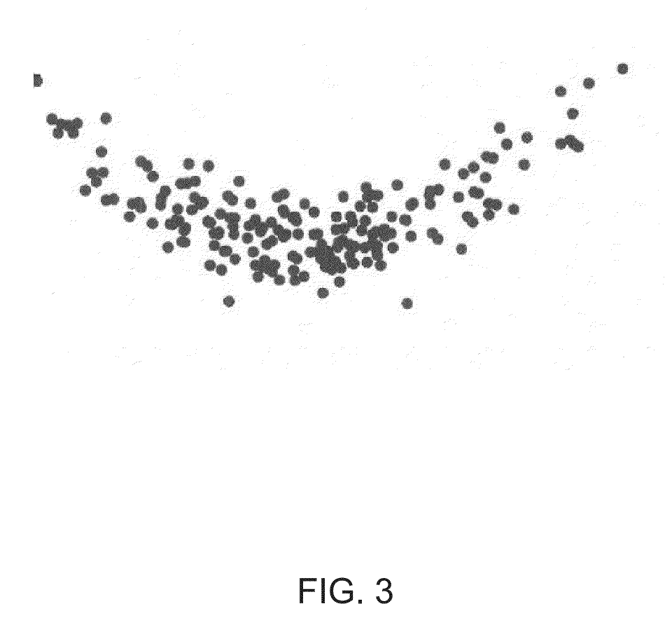

FIG. 3 is a diagram of an example point cloud. The cloud of FIG. 3 is portrayed in a two-dimensional frame for ease of depiction and communication; however, embodiments disclosed herein may be extended to and are equally applicable to a three-dimensional frame. The points of the point cloud shown in FIG. 3 may represent space debris objects generated after a breakup event. As shown in FIG. 3, the point cloud may have non-convex features, that is, all the points along a line segment connecting two points in the point cloud may not necessarily lie within the point cloud itself. Capturing such non-convexity in a resulting three-dimensional model ensures that the debris cloud is accurately represented in any visualization. However, capturing such non-convexity may not be possible using traditional methods.

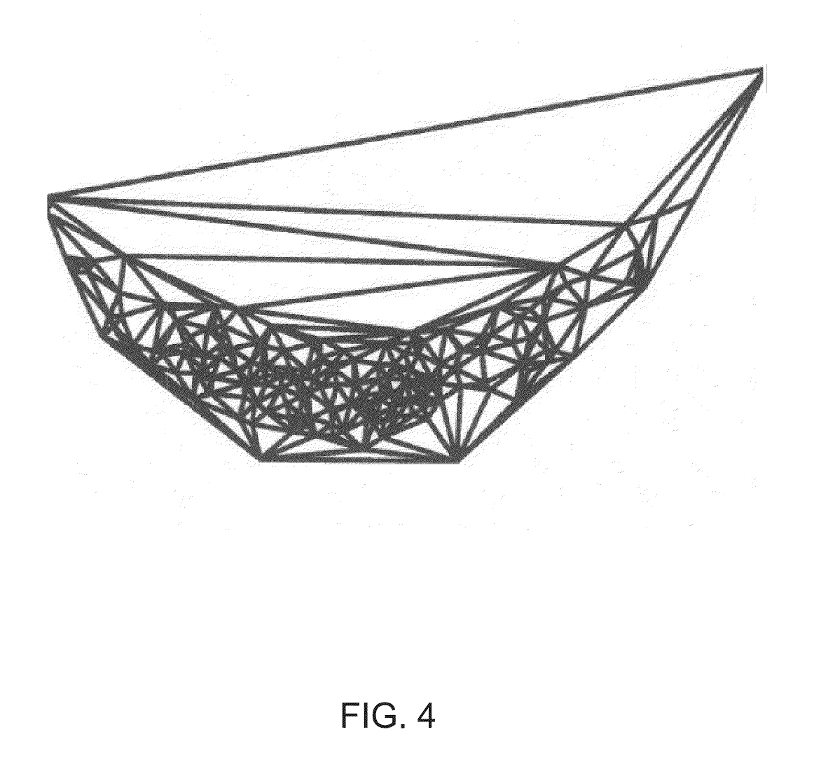

In one embodiment, a Delaunay Triangulation method may be used in part to determine a non-convex boundary around the point cloud. A Delaunay Triangulation method calculates triangles that connect a point to its nearest neighbors. Such triangles maximize the minimum angle of all the angles in the triangulation and attempt to avoid triangles with large angles. FIG. 4 is an example of a Delaunay Triangulation of the point cloud of FIG. 3.

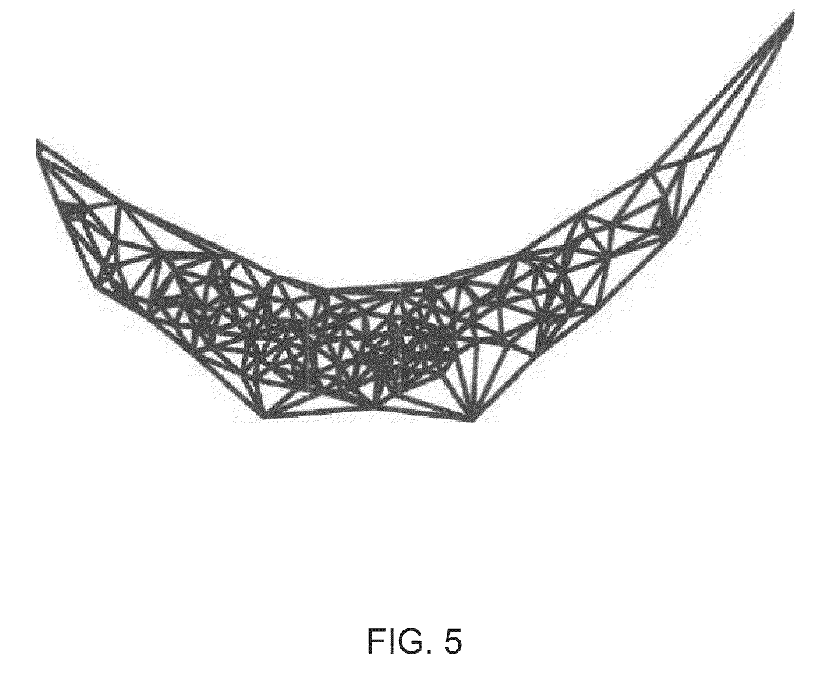

The Delaunay Triangulation of the points by itself does not provide a non-convex boundary. Thus, in one embodiment, an alpha shape method or technique is combined with the Delaunay Triangulation to generate a non-convex boundary around the cloud of points. The alpha shape method is controlled using the parameter alpha, which determines a level of detail in a resulting two or three dimensional model. The alpha shapes technique attempts to fit a circle having a radius of alpha between two arbitrary points. If the ensuing circle has no other points within it, the two points must be on the boundary of the point cloud. The alpha shapes method discovers holes and other non-convex features in a complex point cloud, and allows for finding an arbitrary surface shape. Using the alpha shapes method, and using a screening distance controlled by the alpha parameter, the triangulation may be constrained to remove any triangles with a circumcircle radius larger than alpha. The constrained triangulation may be used to output a mesh which visualizes a positional probability of the space debris objects. FIG. 5 is an example of a constrained Delaunay Triangulation of the point cloud of FIG. 3. As seen in FIG. 5, the triangulation exhibits a non-convex boundary around the point cloud. In one embodiment, the triangulation may be constrained by removing facets having a length greater than alpha.

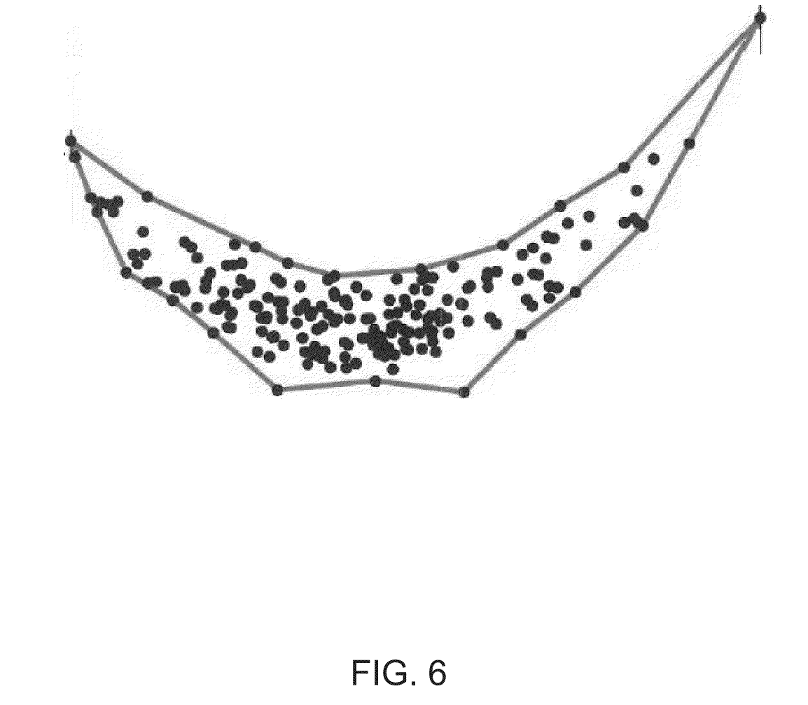

Once the triangulation is constrained, the exterior facets of the surface may be identified by determining which facets are contained in only one simplex. Thus, for example, the interior facets of the surface (those contained in more than one simplex) are removed. The exterior facets may represent a non-convex boundary surface around the cloud of points. In the two-dimensional example, a simplex is a triangle edge; in the three-dimensional example, a simplex is a tetrahedral face. The determined exterior facets lie on the free boundary of the set, and can be seen in the example of FIG. 6, which depicts the exterior facets of the point cloud of FIG. 3. Identifying the exterior facets may maintain a separation between two or more sets of debris points.

Once the boundary surface is created, the boundary surface may be output to a visualization program as a mesh. The boundary surface may be associated with a point in time, such as four hours after a breakup event. A visualization program may use multiple meshes at multiple points of time to animate a Torus surface, which may represent the evolution of a point cloud over time.

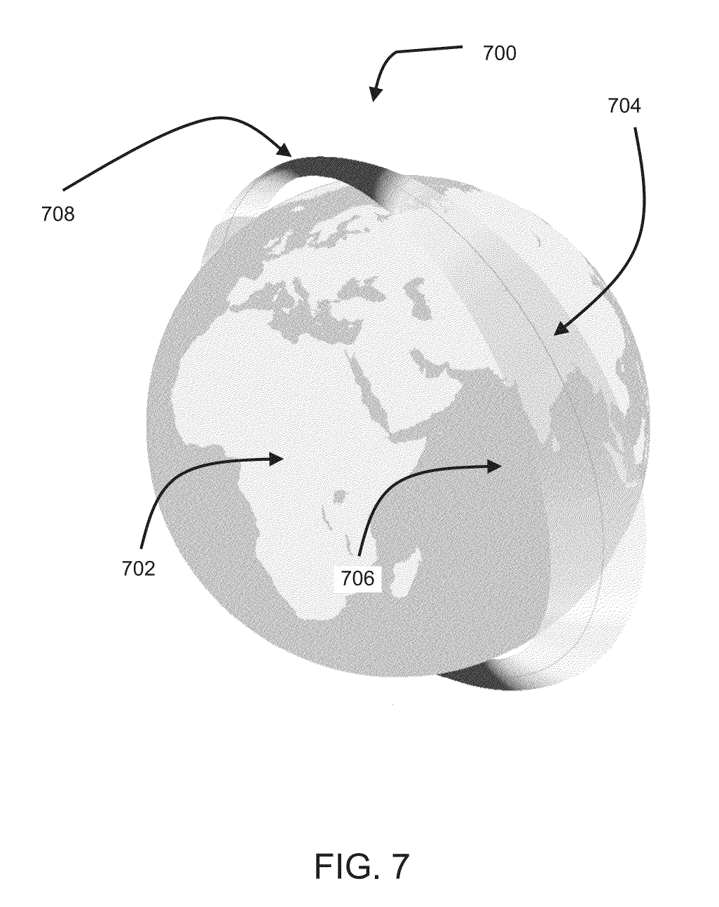

FIG. 7 shows an example three-dimensional pictorial representation 700 of a globe 702 encircled by a graphical representation 704 of space debris particle density, in accordance with one embodiment. The graphical representation 704 has a Torus shape. Although shown in grayscale, the graphical representation 704 may include coloration, shading, volume, shape, transparency, etc. Thus, the position and density of particles may be represented using such various visual indicators. For example, the graphical representation 704 of the space debris particle density may include concentrated regions 708, expanded regions 706, and other regions having various sizes and shapes determined from enveloping curves and boundary points and based on received particle data. These regions 708, 706 may be represented by, for example, a high degree of transparency in the expanded regions 706, indicating low particle probable density (or flux), and a high degree of opacity in the concentrated regions 708, indicating a relatively high particle probable density (or flux).

According to various embodiments, combinations of coloration, grayscale, gradation, shading, volume, shape, transparency, etc. may simultaneously be utilized to provide visual indicators representative of the particle probable density or other pertinent data. In one embodiment, the concentrated regions 708, for example, may be colored red, and the region may be fairly opaque, whereas an expanded region 706 may be represented by another color (blue for example), and may have a high degree of transparency. The transition regions between the expanded regions 706 and the concentrated regions 708 may be represented by gradual changing colors (for example violets to reds) and gradual changing transparencies (about 100% to about 0% for example) to represent the corresponding particle probable densities throughout the graphical representation 704 of the space debris particle density.

Various systems and methods for visualizing the positional probability of space debris particles according to example embodiments will now be described with reference to the accompanying figures.

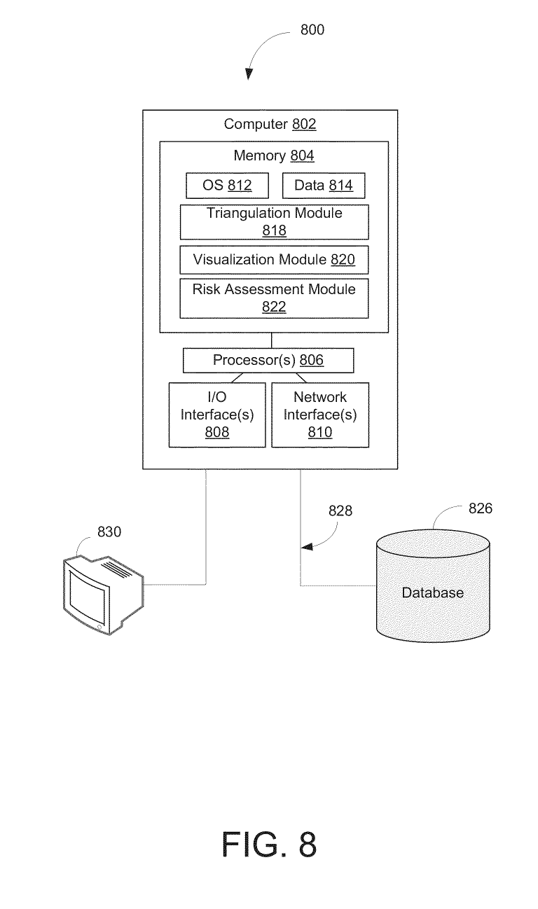

FIG. 8 is a block diagram of an example system 800 for visualizing positional probability of objects in space. The system 800 may include a computer 802 having at least one memory 804 and one or more processors 806 in communication with the at least one memory 804. According to one embodiment, the one or more processors 806 may also be in communication with input/output interfaces 808. In one embodiment, the one or more processors 806 may also be in communication with one or more network interfaces 810. The one or more processors 806 may be in communication with a display 830 for visualizing the rendered results. According to one embodiment, one or more processors 806 may be in communication with one or more databases 826. In one embodiment, the one or more databases 826 may be utilized for storing and retrieving space debris particle data 828, which may include particle initial velocity and/or position. According to one embodiment, the one or more processors 806 may be programmed to, configured to, or operable to retrieve particle data 828 from the one or more databases 826, which may be accessible internally, or externally via the input/output interface 808, or via a network interface 810.

According to one embodiment, the at least one memory 804 may include an operating system 812 and data 814. The memory may also include a triangulation module 818, a visualization module 820, and/or a risk assessment module 822. The one or more processors 806 may be programmed to, configured to, or operable to utilize the particle data 828 in conjunction with the modules 818, 820, 822 to produce a visual rendering of the space debris particle density for display on one or more displays 830. According to one embodiment, the display 830 may include a virtual reality display, a regular computer monitor, or any suitable viewing device.

In one embodiment, the triangulation module 818 may be utilized to generate a boundary around space debris objects based on particle data 828. The particle data 828 may include the position and/or velocity of one or more particles. In one embodiment, triangulation module 818 may use a Delaunay Triangulation combined with an alpha shapes method to generate a boundary around space debris objects.

In one embodiments, the visualization module 820 may utilize the data generated by the triangulation module 818 (i.e., one or more meshes) to produce visual indicators, including coloration, shading, volume, shape, transparency, opacity, etc. for visualization on the display 830. In one embodiment, risk assessment module 822 may indicate the risk to an orbiting satellite that the satellite will collide with a visualized debris cloud. In one embodiment, risk assessment module 822 may communicate such a risk measurement to a navigational system of an orbiting satellite. Such information may be used to control the path of an orbiting satellite, either by a human operator or by hardware and/or software associated with the orbiting satellite.

In one embodiment, any combination of the modules 818 and 820 may be utilized to provide different representations or views of the positional probabilities of the space debris objects. For example, an operator may pan, zoom, and navigate within a 3D rendering of the particle positional probabilities to assess the risk of collisions. In some embodiments, the 3D rendering may be animated.

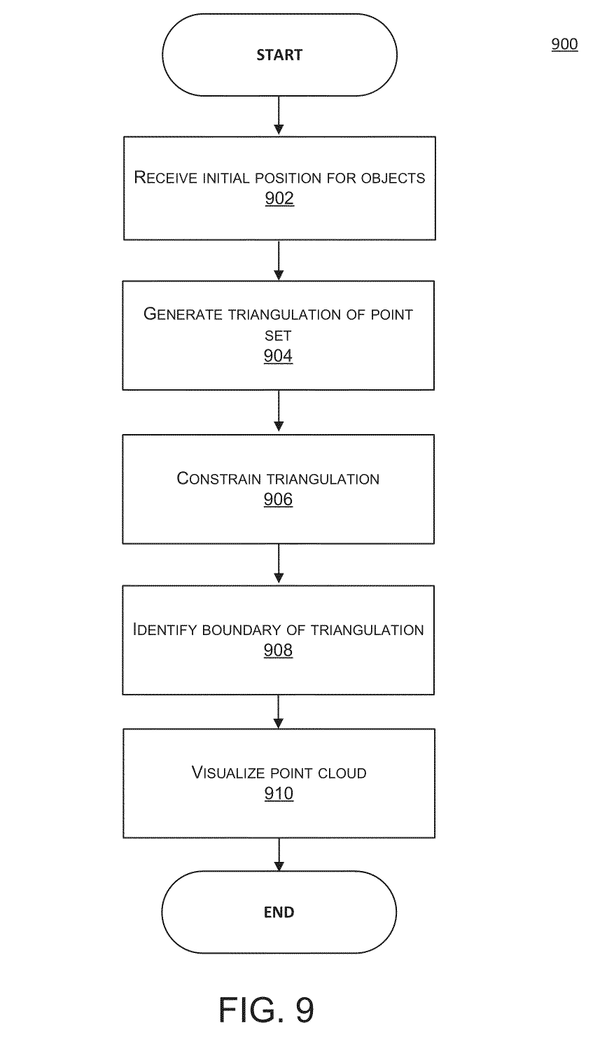

FIG. 9 is a flow diagram of an example method 900 for visualizing the positional probability of a plurality of objects in space, according to one embodiment. Method 900 begins at block 902.

At block 902, an initial or first position for each object in the plurality of objects may be received. The initial positions correspond to a given time, for example, two hours after a breakup event, four hours after a breakup event, or any other given time as desired by an operator of a system implementing method 900. The initial positions may be received from an external data source that observes the positions of the objects after a breakup event. Additionally or alternatively, the received initial positions may include simulation data representing the initial conditions of the objects after a simulated breakup event. The received initial positions may comprise a point set. Further, the point set may have non-convex features. In one embodiment, a set of predetermined times (e.g., 2 hours after breakup event, 4 hours after breakup event) are used, and the initial positions used at block 902 correspond to each predetermined time. In one embodiment, the positions at block 902 may be observed in real-time after a breakup event.

At block 904, a triangulation of the point set received at block 902 may be generated. In one embodiment, the triangulation may be a Delaunay triangulation of the point set received at block 902. The resulting triangulation may appear as described above with respect to FIG. 4. In three dimensions, a tetrahedralization may be generated, as opposed to a triangulation in two dimensions. In one embodiment, the triangulation or tetrahedralization produces simplices; in two dimensions, the simplices are triangles, while in three dimensions, the simplices are tetrahedral faces.

At block 906, the triangulation generated at block 904 may be constrained to remove large triangles in the generated triangulation. In one embodiment, the triangulation may be constrained using an alpha shapes method. The alpha value used at block 906 may be selected by an operator of a system implementing method 900. Additionally or alternatively, multiple values of alpha may be used to constrain the triangulation, and a user may select an appropriate constrained triangulation based on various criteria. In one embodiment, the value of alpha selected for the constrained triangle may correspond to the size of a satellite of interest. Selecting the alpha value in this manner may assist in determining the probability that a satellite will collide with an object in the plurality, or in determining the probability that a satellite will pass through the point cloud. In one embodiment, constraining the triangulation results in a non-convex boundary around the plurality of objects. Such a constrained triangulation may appear as described above with respect to FIG. 5. A non-convex boundary may result in elimination of large areas where no particles exist, and may avoid overestimating the volume of particles.

In one embodiment, based on the alpha value, constraining the triangulation may identify voids or holes in the point cloud. Thus, in one embodiment, constraining the triangulation generated at block 904 may result in multiple clusters of points, if the point cloud distribution reveals voids greater than the alpha parameter value.

At block 908, using exterior facets of the triangulation, a boundary of the constrained triangulation may be identified to create a wireframe mesh. The exterior facets may be identified by determining which facets are contained in only one simplex of the constrained triangulation. The identification at block 708 may result in a boundary surface as described above with respect to FIG. 6.

At block 910, the wireframe mesh may be used to visualize the point cloud. The visualization may be performed in one embodiment by visualization module 820 of system 800. For example, the wireframe mesh may be output to visualization software executing on system 800. In one embodiment, the wireframe mesh may be time stamped with one or more time intervals. Visualization module 820 may only visualize or analyze the mesh during time intervals for time intervals in which the mesh is valid.

In one embodiment, a second position for each of the objects may be received. The second position may correspond to a later time after the breakup event. For example, the first position for each of the objects may represent the objects four hours after the breakup event, while the second position may represent the objects eight hours after the breakup event. Based on the second position, a mesh may be generated in accordance with blocks 904, 906, 908, and 910 of method 900. Visualization module 820 of FIG. 8 may further be configured to animate the movement of the objects and meshes between the first and second times.

In one embodiment, visualization module 820 may color or shade the resulting visualization or animation according to the density distribution of the wireframe mesh. For example, portions of the mesh that include more objects may be colored red, while portions of the mesh that include few objects may be colored blue. Other visualization methods are possible as well. For example, varying levels of gray may be used to visualize the density distribution of the wireframe mesh. Alternatively, dense portions may be darker, while less dense portions may be partially opaque. In one embodiment, the wireframe mesh may be used to determine a probability that an object within the wireframe mesh (i.e., a piece of space debris) will collide with an orbiting satellite.

In one embodiment, multiple positions for each of the objects may be received, corresponding to multiple time intervals. Using the received multiple positions, the distribution of space debris may be animated to display a Torus, or three-dimensional surface, which encloses the cloud of debris particles. The visualized Torus may be colored, or transparency levels may be applied, to visualize the debris particle density in each portion of the Torus. Coloration or transparency may be calculated in part by using the volume of each section of the Torus. Further, the coloration or transparency may approximate that debris spreads evenly between sections of the Torus.

In some embodiments, the 2D boundaries or the 3D representations may be utilized to identify potential collision threats or a probability of a collision between an orbiting satellite and cloud of debris particles. In one embodiment, risk assessment module 822 may determine the likelihood that an orbiting satellite will collide with a visualized cloud. In one embodiment, the 2D boundaries or the 3D representations may be based, at least in part on time-dependent positional probabilities of the objects in space. In some embodiments, the objects may represent space debris or satellites.

Accordingly, embodiments disclosed herein can provide the technical effects of creating certain systems and methods that provide visualizations of the risk of collision with space objects. Some embodiments may provide the further technical effects of providing systems and methods for developing a 3D boundary for a debris cloud suitable for visualization and further technical analysis. Some embodiments can provide the further technical effects of providing systems and methods for using transparency and coloration to convey intuitive sense of collision risk based on technical analysis. Some embodiments can provide the further technical effects of providing systems and methods for a visualization model that evolves with time, as dictated by dynamics of the model.

In one embodiment, the system 800 for visualizing positional probability of objects in space may include any number of software applications that are executed to facilitate any of the operations.

In one embodiment, one or more input/output interfaces may facilitate communication between the system 800 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc. may facilitate user interaction with the system 800. The one or more input/output interfaces may be utilized to receive or collect data and/or user instructions from a wide variety of input devices. Received data may be processed by one or more computer processors as desired in various embodiments and/or stored in one or more memory devices.

One or more network interfaces may facilitate connection of the system 800 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ enabled network, a Wi-Fi™ enabled network, a satellite-based network, any wired network, any wireless network, etc. for communication with external devices and/or systems. As desired, embodiments may include the system 800 with more or less of the components illustrated in FIG. 8.

Embodiments are described above with reference to block and flow diagrams of systems, methods, apparatuses, and/or computer program products according to some embodiments. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, some embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

While embodiments of the disclosure have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose embodiments to enable any person skilled in the art to practice the embodiments, including making and using any devices or systems and performing any incorporated methods. The patentable scope of the embodiments is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for visualizing a positional probability of a plurality of objects in space, comprising:
receiving, by a computing system comprising one or more processors, an initial position for each of the plurality of objects at a given time;
determining, by the computing system, a non-convex boundary around the plurality of objects; and
generating, by the computing system, a three-dimensional representation of the positional probability of the objects in space based on the non-convex boundary.

2. The method of claim 1, wherein determining a non-convex boundary around the plurality of objects includes calculating a Delaunay triangulation of the plurality of objects.

3. The method of claim 2, wherein determining a non-convex boundary around the plurality of objects further includes constraining the calculated Delaunay triangulation according to an alpha shapes method.

4. The method of claim 1, wherein the plurality of objects represents space debris.

5. The method of claim 1, further comprising determining a probability that an object in the plurality of objects will collide with an orbiting satellite.

6. The method of claim 1, wherein the three-dimensional representation of the positional probability of the objects is space is generated using a wireframe mesh.

7. The method of claim 6, further comprising coloring the wireframe mesh according to the positional probability of the objects in space.

8. The method of claim 1, wherein the three-dimensional representation of the positional probability of the objects is a first three-dimensional representation, and further comprising:
receiving, by the computing system, a second position for each of the plurality of objects at a second given time;
determining, by the computing system, a second non-convex boundary around the plurality of objects;
generating, by the computing system, a second three-dimensional representation of a positional probability of the objects based on the non-convex boundary; and
constructing an animation of an object cloud based on the first and second three-dimensional representations of the positional probability of the objects.

9. A system for visualizing a positional probability of a plurality of objects in space, comprising:
at least one memory for storing computer-executable instructions; and
at least one processor in communication with the at least one memory, the processor configured to execute the computer-executable instructions to:
receive an initial position for each of the plurality of objects at a given time;
determine a non-convex boundary around the plurality of objects; and
generate a three-dimensional representation of the positional probability of the objects in space based on the non-convex boundary.

10. The system of claim 9, wherein the non-convex boundary around the plurality of objects is determined by calculating a Delaunay triangulation of the plurality of objects.

11. The system of claim 10, wherein the non-convex boundary around the plurality of objects is determined by constraining the calculated Delaunay triangulation according to an alpha shapes method.

12. The system of claim 9, wherein the plurality of objects represents space debris.

13. The system of claim 9, wherein the processor is further configured to execute the computer-executable instructions to determine a probability that an object in the plurality of objects will collide with an orbiting satellite.

14. The system of claim 9, wherein the three-dimensional representation of the positional probability of the objects is space is generated using a wireframe mesh.

15. The system of claim 14, wherein the processor is further configured to execute the computer-executable instructions to color the wireframe mesh according to the positional probability of the objects in space.

16. The system of claim 9, wherein the three-dimensional representation of the positional probability of the objects is a first three-dimensional representation, and wherein the processor is further configured to execute the computer-executable instructions to:
receive a second position for each of the plurality of objects at a second given time;
determine a second non-convex boundary around the plurality of objects;
generate a second three-dimensional representation of a positional probability of the objects in space based on the non-convex boundary; and
construct an animation of an object cloud based on the first and second three-dimensional representations of the positional probability of the objects.

17. A computer program product comprising a computer-readable medium having computer-executable instructions embodied therein, the computer-executable instructions when executed by at least one processor perform the operations comprising:
receiving, by a computing system comprising one or more processors, an initial position for each of a plurality of objects at a given time;
determining, by the computing system, a non-convex boundary around the plurality of objects; and
generating, by the computing system, a three-dimensional representation of the positional probability of the objects based on the non-convex boundary.

18. The computer program product of claim 17, wherein determining a non-convex boundary around the plurality of objects includes calculating a Delaunay triangulation of the plurality of objects.

19. The computer program product of claim 18, wherein determining a non-convex boundary around the plurality of objects further includes constraining the calculated Delaunay triangulation according to an alpha shapes method.

20. The computer program product of claim 17, wherein the objects represent space debris.
